(19) United States
(12) Patent Application Publication
(10) Pub. No.: US 2004/0003349 A1
(43) Pub. Date: Jan. 1, 2004

(54) Content segments

(75) Inventors: Peter Francis Ostertag, Woodinville, WA (US); Alex Mogilevsky, Bellevue, WA (US); Michael J. Hillberg, Kirkland, WA (US); Nicholas Kramer, Seattle, WA (US)

Correspondence Address: KLARQUIST SPARKMAN LLP, 121 S.W. SALMON STREET, SUITE 1600, PORTLAND, OR, 97204, US

(73) Assignee: Microsoft Corporation

(21) Appl. No.: 10/323,087

(22) Filed: Dec. 18, 2002

Related U.S. Application Data
(63) Continuation-in-part of application No. 10/186,050, filed on Jun. 28, 2002.

(51) Int. Cl. G06F 15/00

(52) U.S. Cl. 715/514; 715/513

(57) ABSTRACT

A span of data in content having an associated hierarchical representation can be specified as a content segment. The span of data can be specified without modifying the hierarchical representation for the content. Events and properties can be specified for the content segment. If desired, content segments can be stacked on top of one another, and they can overlap. Disjoint (e.g., non-contiguous) content segments can be designated, and sub-segments can be processed. A variety of operations can be performed for the content segments, and a user interface service can provide a variety of services for content segments.

### CROSS REFERENCE TO RELATED APPLICATIONS

This application is a continuation-in-part of Ostertag et al., U.S. patent application Ser. No. 10/186,050, filed Jun. 28, 2002, which is hereby incorporated herein by reference.

### TECHNICAL FIELD

The technical field relates to internal representations of user interfaces and documents, such as internal representations accessed by computer programs.

### BACKGROUND OF THE INVENTION

As software technology progresses, the nature of content evolves. In the early days of computer science, plain text was used to represent the majority of content. For example, at one time, most input and output of computer programs was collected or presented as strings of letters and numbers, such as ASCII characters. As computer science progressed, other content elements, such as images, sounds, and video became available.

Today, user interfaces and documents can contain a variety of content, including mixed text, graphical user interface elements, and other content. The internal representation of such content is typically more complex than a simple, linearly arranged string of characters.

For example, content may be associated with a hierarchical representation that can affect presentation of the content. Such a hierarchical representation may include nodes that represent formatting directives or user interface elements. The hierarchical representation is thus useful when presenting or rendering the content.

However, in some scenarios, it may be cumbersome to repeatedly modify the hierarchical representation to designate spans of content. For example, certain spans may span hierarchy boundaries and thus have no legal representation in the hierarchy unless the hierarchy is broken into smaller pieces.

Accordingly, the complexity of dealing with content has increased, and there is a need for an improved way to represent and manipulate spans of content for modem user interfaces.

### SUMMARY OF THE INVENTION

As described herein, arbitrary spans of content in a user interface or a document can be specified in a variety of scenarios for a variety of purposes. Such spans can be implemented via a mechanism called a “content segment.” In one implementation, content segments can be specified, invoked, and otherwise used without modifying the hierarchical representation associated with the underlying content. In another implementation, arbitrary properties can be associated with arbitrary spans of content in hierarchical and non-hierarchical scenarios. Such properties can affect the rendering of the associated content.

Various operations upon the spans are supported. For example, content associated with the content segment can be cloned (e.g., copied) without modifying the hierarchical representation of the underlying content.

Events can be associated with content segments. Upon detection of the event for the content segment, a function can be invoked. For example, when a pointer is positioned over a visual depiction of the content segment, an appropriate function can be invoked for the content segment.

When rendering content associated with a content segment, properties of the content segment can be taken into account. Nodes in the associated hierarchical representation can also affect properties reported for content within the content segment.

If desired, the content segments can be stacked via a z-order mechanism. Content segments having a higher (e.g., visually closer) z-order can take precedence over those having a lower z-order. Determining precedence (e.g., for property resolution and event handing) can also include other factors besides z-order.

If desired, a content segment can be defined over a non-contiguous span of content in a user interface or document.

Further, a content segment can comprise sub-segments. If desired, such sub-segments can have separate properties or be associated with different functionality upon detection of an event.

If desired, a content segment can overlap other content segments and span hierarchical boundaries within a hierarchical representation associated with the underlying content.

Additional features and advantages will be made apparent from the following detailed description of illustrated embodiments, which proceeds with reference to the accompanying drawings.

### BRIEF DESCRIPTION OF THE DRAWINGS

FIG. 1 is an exemplary hierarchical representation associated with content.

FIG. 2 is a screen shot of exemplary presented content, such as that having the representation shown in FIG. 1.

FIG. 3 is a screen shot of presented content, including an exemplary implementation of a content span.

FIG. 4 is an exemplary markup representation causing a problem due to a span that crosses a hierarchy boundary.

FIG. 5 is a flowchart of an exemplary method for designating a span of content.

FIG. 6 is a block diagram of an exemplary representation of content with an associated hierarchical representation and a defined content segment.

FIG. 7 is a block diagram of a more detailed exemplary representation of content with an associated hierarchical representation and a defined content segment.

FIG. 8 is a flowchart of an exemplary method for processing content segments.

FIG. 9 is a flowchart of an exemplary method for processing events for content segments.

FIG. 10 is a flowchart of an exemplary method for processing properties for content segments.

FIG. 11 is a flowchart of an exemplary method for handling a request for properties associated with a particular location within content.

FIG. 12 is a block diagram showing exemplary stacking of content segments.

FIG. 13 is a block diagram showing exemplary non-contiguous content segments.

FIG. 14 is a flow chart showing an exemplary method for rendering content in light of content segments defined for the content.

FIG. 15A depicts a quad tree for tracking content segments.

FIG. 15B depicts the quad tree of FIG. 15A after having added additional data.

FIG. 16 shows exemplary source code for achieving exemplary operation of the technologies.

FIG. 17 shows exemplary source code for achieving exemplary operation of the technologies, including an event handler.

FIG. 18 depicts an exemplary hierarchical representation associated with exemplary operation of the technologies.

### DETAILED DESCRIPTION OF THE INVENTION

### Overview

The technologies described herein can be provided by a user interface service. For example, programs can invoke the various features, such as content segments, to take advantage of the described technologies.

### Exemplary Hierarchical Representation

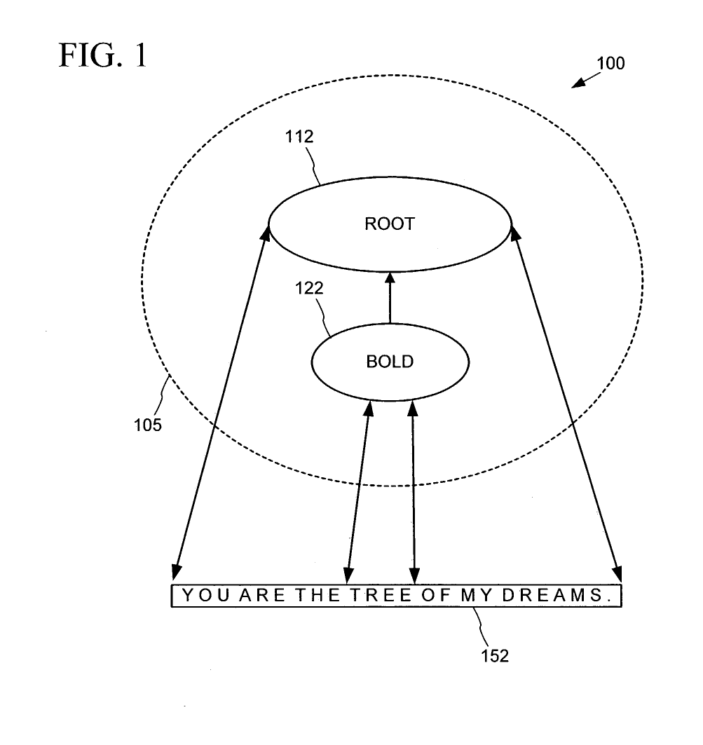

FIG. 1 shows an exemplary representation 100 associated with content to be presented to a user. Such content can be presented within a document or in a user interface for controlling program functionality. The pictured representation 100 can be stored in a computer readable medium to represent the content as it is processed (e.g., rendered, edited, searched, and the like). In any of the examples described herein, the hierarchical data structure can be stored as a tree data structure as shown.

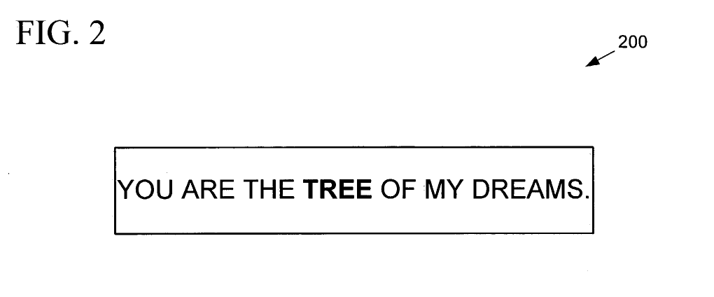

In the example, 100, a sequential store 152 of content includes the sentence, “You are the tree of my dreams.” A hierarchical representation 105 associated with the sequential store 152 can be used for a variety of purposes, such as for storing user interface elements or formatting directives for the content in the sequential store 152. In the example, the hierarchical representation 105 includes a root node 112 and a bold node 122. The effect of the bold node 122 is to designate the word “tree” as bold. Accordingly, when the representation 100 is rendered, it appears as the rendition 200 shown in FIG. 2 (i.e., the word “tree” is shown in bold).

The hierarchical representation 105 can be useful in a number of scenarios. For example, when representing a markup language (e.g., XML or HTML), the nodes in the hierarchical representation 105 can correspond to tags in the markup. Rendering, editing, and searching functions can thus be performed efficiently on the representation 105 if desired. Conversion from the representation to markup (and vice versa) is thus easily achieved. There thus exists an equivalent markup version of the pictured representation 100.

Also, given a particular location (e.g., a character) in the sequential content 152, it can be determined which nodes enclose the location and determine how to render the location (e.g., to make it bold or otherwise format it). Such an approach is sometimes called a “bottom-up” view.

In practice, the exemplary hierarchical representation 105 can vary from that shown. For example, additional nodes and levels can be introduced into the hierarchy as desired.

### Exemplary Span of Content

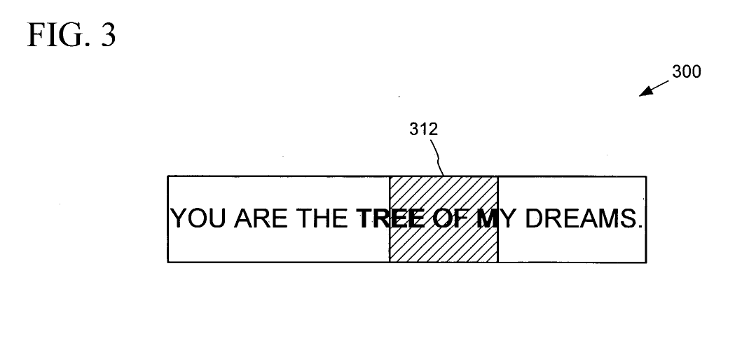

FIG. 3 shows a screen shot of exemplary rendered content 300 in which an exemplary span 312 of content has been designated. Such spans can be useful for a variety of reasons. In the example, the span has been selected (e.g., via a pointing device such as a mouse or trackball). Such selection is useful to designate content on which an editing or other operation is to be performed. To indicate that the span 312 has been selected, it is shown as visually highlighted (e.g., presented in a different color or shading).

### Problem with Spans Crossing a Boundary in the Hierarchy

One approach to representing the span 312 internally would be to modify the associated hierarchy (e.g., the hierarchy 105 of FIG. 1). However, there are a number of problems with such an approach.

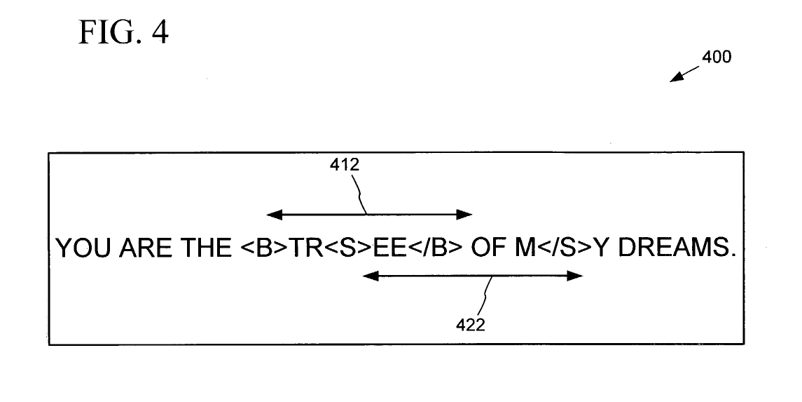

For example, the span may cross a hierarchy boundary. In the example, the span 312 crosses the “bold” boundary. As shown in FIG. 4, a hypothetical markup representation 400 of the rendered content 300 is shown using the “B” tag for bold and the “S” tag for selected. However, the representation is not legal markup (e.g., not legal XML or XHTML) because the tags are not properly nested as is shown by the extent of the content 412 and 422 covered by the tags. Further, the hierarchical relationship between the “B” and “S” tags is ambiguous. It is not clear if one should or could be the parent of another.

In order to maintain a legal markup representation, a number of tags could be added to the markup to denote which portions of the content are bold, which are selected, and which are selected and bold. However, such an approach can lead to excessive rearrangement and manipulation of the underlying hierarchical representation, especially if the selected text changes often, as is likely to happen in the example.

Accordingly, a facility described herein as a “content segment” can be used by which spans of content (e.g., the span 312) can be designated without modifying or otherwise disrupting the associated hierarchy.

### Exemplary Uses for Content Segments

The content segments described herein can be used to advantage in a variety of scenarios. As described herein, they are particularly useful for implementing text selection (e.g., via a pointer or other mechanism). However, other uses are possible.

For example, a content segment can be defined to provide “tool tip” functionality (e.g., upon hovering a mouse pointer over a content segment, a helpful message is displayed). When performing handwriting recognition, a content segment can be defined for the recognized word that stores the original ink (e.g., handwriting) from which the word was recognized. Such an arrangement can be useful when an unexpected or incorrect word appears in the text to observe the original handwriting associated with the word (e.g., by hovering over or otherwise activating the word).

Various accessibility features can be provided (e.g., a word can be spoken or enlarged when activated via a mouse pointer or other action).

In certain text-entry scenarios (e.g., entry of Chinese characters), a number of characters may be input to generate the ultimately desired character. A content segment can be defined in which the original characters used to generate the final character were used. The original characters can then be considered or modified to generate a different final character.

Annotations can be attached to a span of text via content segments. Also, revision tracking can be accomplished via content segments. For example, a content segment can be defined to span added text and indicate who added the text and when it was added. Still further, text highlighting can be implemented.

Various clipboard functionality can be provided. For example, selected text can be designated as a content segment. Deletion, copying, and moving can be accomplished for the selected text indicated by the content segment. When performing such operations, the hierarchy may end up being modified (e.g., if a span of text is deleted). Such modification or tools for such modification can be provided automatically by a user interface service.

Spell checking functionality can be implemented via content segments. For example, detected misspelled words can be designated as a content segment and visual properties (e.g., red underlining) can be set for the content segment. When the content segment is activated (e.g., right clicked), possible correctly spelled words can be presented.

Content segments can also be used for speech recognition. For example, the original (e.g., speech) data associated with a recognized word can be stored and associated with a content segment. The original spoken word can then be easily retrieved by activating the word (e.g., via a right click).

Many other scenarios are possible.

### Exemplary Designation of Span of Content

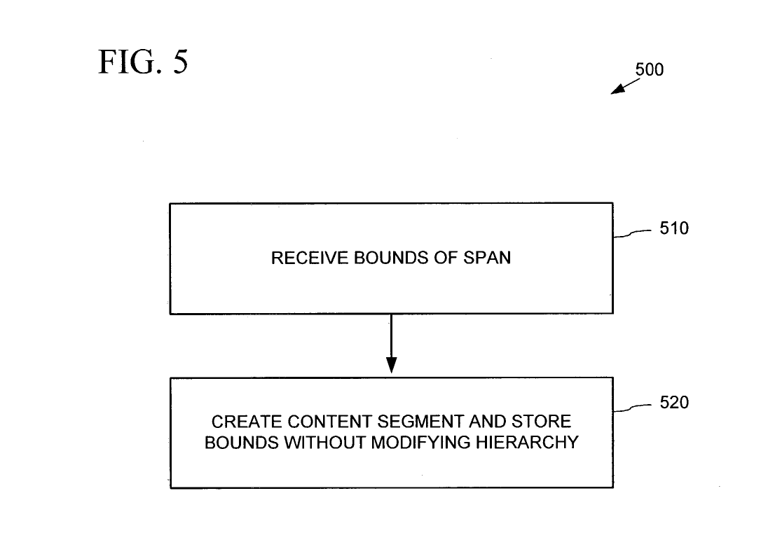

FIG. 5 shows an exemplary method 500 for designating a span of content. Such a method can be provided as part of a user interface service. At 510, the bounds of the span are received (e.g., a beginning and end of the span). At 520, a content segment is created and the bounds of the span are stored without modifying the hierarchy (e.g., the hierarchical representation associated with the content). For example, the bounds can be stored separate from the hierarchy. The bounds can be stored in a different format from that supplied in 510 (e.g., a pointer or some other mechanism can be used in 510, 520, or both).

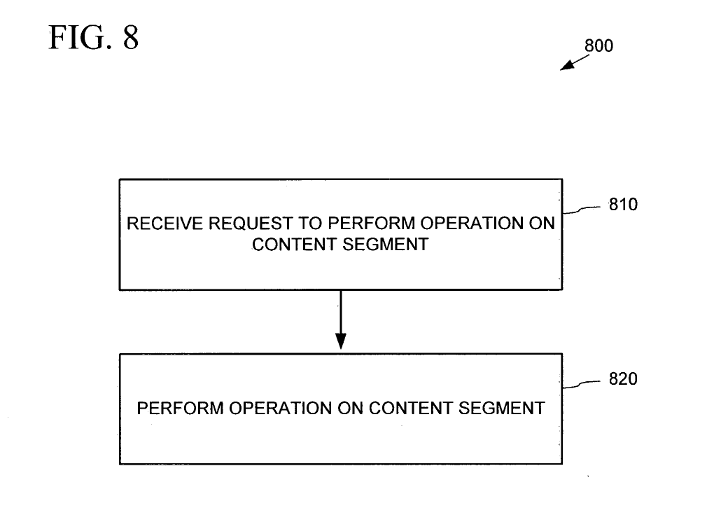

An exemplary representation 800 of content to be rendered is shown in FIG. 8. The example shows a representation of the rendition 300 of FIG. 3. As shown, the representation 800 can be identical to the representation 100 of FIG. 1, except that the content segment 870 has been added to store the bounds of the selected span 312. The hierarchy 105 has not been modified.

The illustrated approach can be particularly useful for temporary changes to the representation of the content (e.g., during selection of text and the like).

### More Detailed Exemplary Representation Having a Content Segment

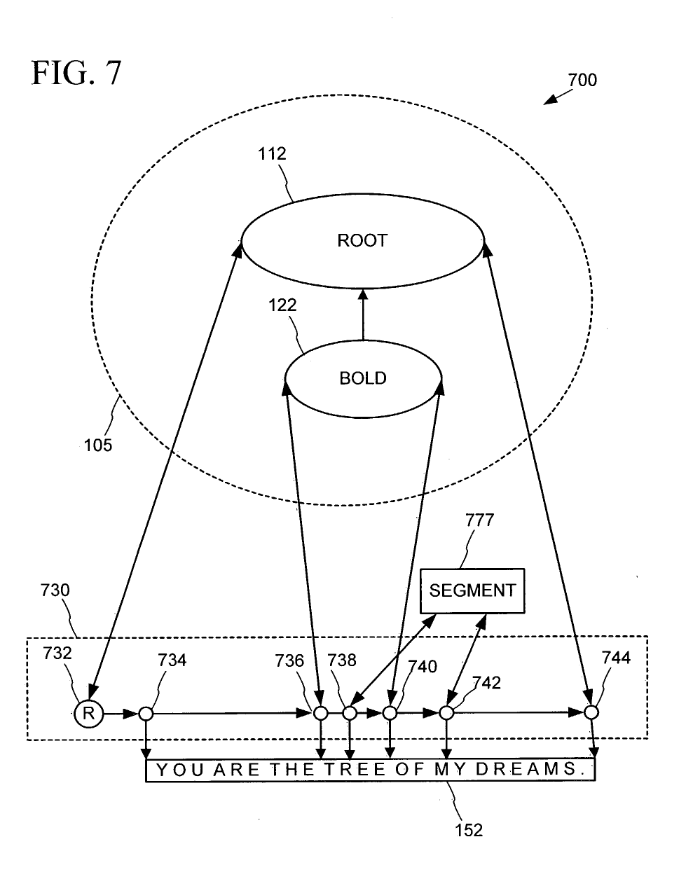

FIG. 7 shows a more detailed exemplary representation 700 of content and an associated content segment 777. In the example, the representation additionally includes a linking data structure 730 (i.e., the nodes 732, 734, 736, 738, 740, 742, and 744). The linking data structure 730 can provide a desirable feature in that the nodes indicate locations within the content 752, but are resilient to changes in the content 752. For example, although other implementations are possible (e.g., a linked list or an array), the linking data structure 730 can be implemented as a splay tree storing the number of characters in its left sub-tree. In this way, every one of the nodes of the linking data structure 730 need not always be updated when modifying the content 752. Further, the splay tree can re-balance itself based on operations performed on it (e.g., adding text to the content 752). In this way, searching for character positions can be more efficiently accomplished.

The linking data structure 730 can thus link both the hierarchical representation 105 and content segments (e.g., the content segment 777) to the content. When a request to create a content segment is received, appropriate nodes can be created in the linking data structure 730, if needed. In some cases, an appropriate node may already exist.

As shown, the content segment 777 stores the bounds of the content span (e.g., that shown as the selected span 312 in FIG. 3). Storing the bounds may affect the linking data structure 730, but does not modify (e.g., disturb) the hierarchy 105. Instead of storing a single content segment, in any of the examples, one or more content segments can be stored.

Although the example shows the linking data structure 730 includes nodes for content segment boundaries, other implementations are possible. For example, appropriate tracking of content segment boundaries can be performed in response to detection of content changes.

### Exemplary Characteristics of Content Segments

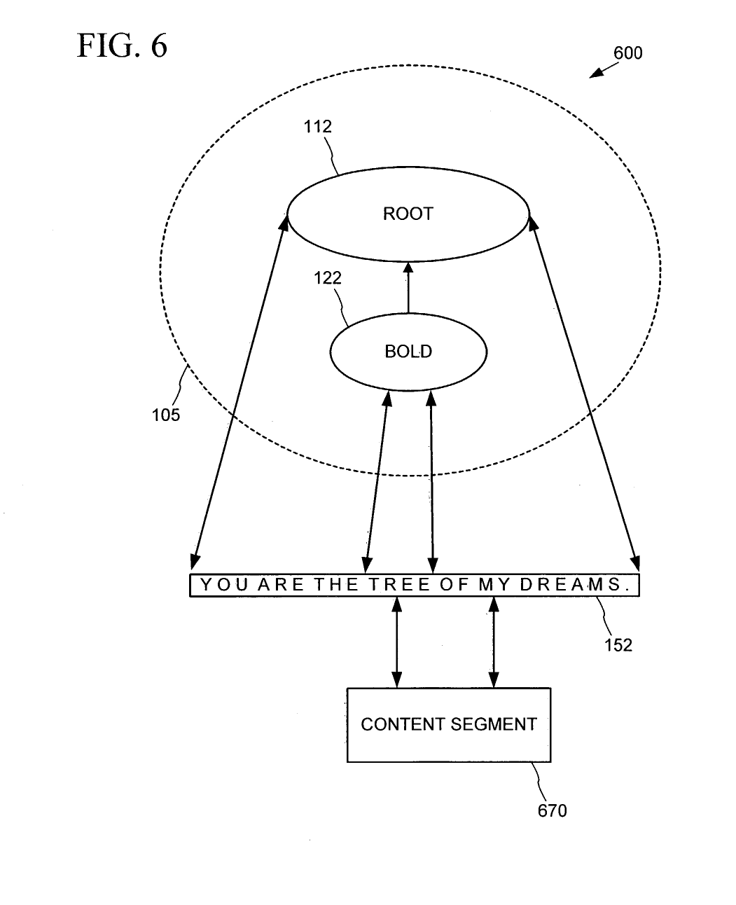

A content segment (e.g., such as that defined in FIG. 5 and shown in FIGS. 6 and 7) can support a variety of features. For example, content segments can be overlapped. Content segments can cross hierarchy boundaries (e.g., span two nodes or span content inside and outside a node). In some implementations, the content segment is resilient to modification of hierarchy because the bounds are represented in a linking data structure (e.g., the structure 730). Resiliency is exhibited in that as content is added, the bounds move automatically without having to update them.

Further, given a particular location within the content (e.g., a character position), it is possible to find which segment(s) span the location (e.g., via “bottom-up” navigation). If desired, content segments can be assigned an arbitrary “segment type” for extensibility.

Content segments can be user interface or data-only entities and can change from one to the other (e.g., on the fly). Such an approach allows scenarios such as annotations in various formats or languages as part of a document, and having a choice as to which are displayed.

Further, user interface content segments can be implemented to affect property determination and event routing. Data-only content segments can be implemented to not affect property determination and event routing. Finally, the segments can be stored non-hierarchically.

### Exemplary Persistence of Designation of Span of Content

Although content segments can be used effectively when temporarily designating spans of content (e.g., user selection of text), it may be desirable to persist the content segments for later recall. Such an arrangement can be accomplished by storing the segments along with, but not affecting the persistence of the associated hierarchical representation.

Any number of persistence scenarios is possible. Although the markup of FIG. 4 is illegal in certain markup languages, it could be used as a model for persisting the associated content segments.

### Exemplary Processing for Content Segments

FIG. 8 shows an exemplary method 800 for processing content segments. At 810, a request is received to perform an operation on a content segment. At 820, the operation is performed on the content segment. In the example, the content segment can designate a span of content without modifying the hierarchical representation associated with the content.

### Exemplary Event Handling

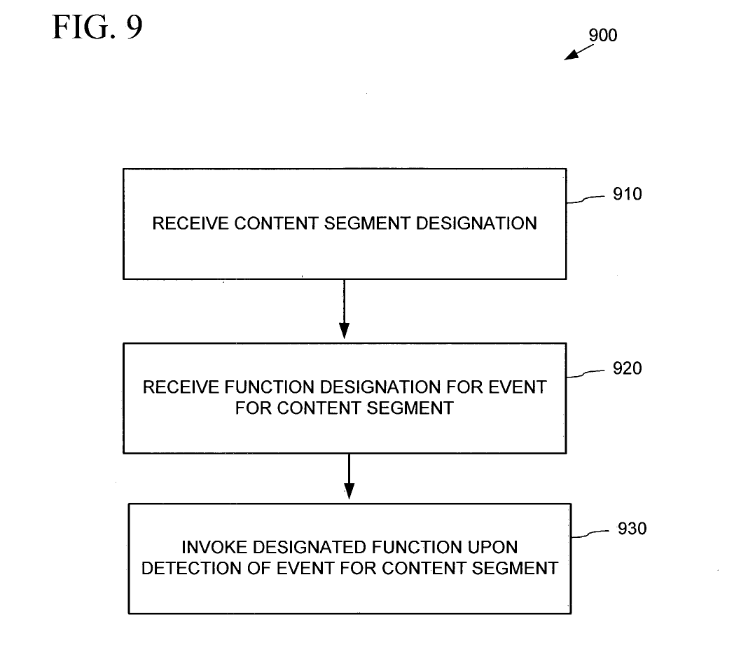

Content segments can also be particularly useful for handling events. FIG. 9 shows an exemplary method 900 for processing events for content segments. Such a method can be provided by a user interface service. In the example, a designation of a content segment is received at 910 (e.g., a span of content is identified as to be represented by the content segment). At 920, a function designation for an event for the content segment is received. For example, a function can be provided to be invoked when a particular event is detected. At 930, upon detection of the particular event for the segment, the designated function is invoked.

Specifying events can be useful in a variety of scenarios, such as detecting when a user interface pointer is positioned over the span of content associated with a segment, and the like.

If desired, the events can be tunneled and bubbled. For example, events can be directed to the segments first and then to nodes in the hierarchical representation (e.g., which may represent user interface elements).

To accomplish the described arrangement, a handler can be associated with the content segment. The handler can indicate which function is to be invoked upon detection of the appropriate event.

### Exemplary Events

A variety of events can be provided. If desired, custom events can be defined. However, a user interface service can provide a variety of events to assist in presenting and interacting with a user interface.

For example, events for when a segment acquires (e.g., gets) or loses the focus can be generated. Also, events for when the pointer moves within the segment (e.g., MouseMoveEvent), when the segment is clicked (e.g., MouseDownEvent), the mouse is released within the segment (e.g., MouseUpEvent), and a wheel is activated over the segment (e.g., MouseWheelEvent) can be provided.

Any number of other events can be supported, including those for when input is received via a keyboard, mouse, pen/stylus, joystick, or speech. Further, events can be supported for arbitrary commands, such as those activated via speech recognition.

Additionally, an event can be provided when the segment changes (e.g., a property of the segment changes).

If desired, event handlers for a content segment can take precedence over those specified in the hierarchy. Precedence rules can be defined generally (e.g., segments take precedence over nodes or vice versa), event-specific (e.g., for a particular event, nodes take precedence over segments or vice versa), or some combination thereof.

### Exemplary Designation of Properties For a Span

If desired, arbitrary properties (e.g., having an associated property value) can be associated with a span of content. For example, such arbitrary properties can be associated with a content segment. Custom properties can thus be supported by a user interface service because such properties need not be known to (e.g., need not be recognized by) the user interface service.

Although simple properties can be supported, a more extensive implementation of properties can be achieved. For example, properties can participate in dependencies and expressions; be defined in property sheets; be inherited; or some combination thereof.

### Exemplary Method for Processing Properties For Content Segments

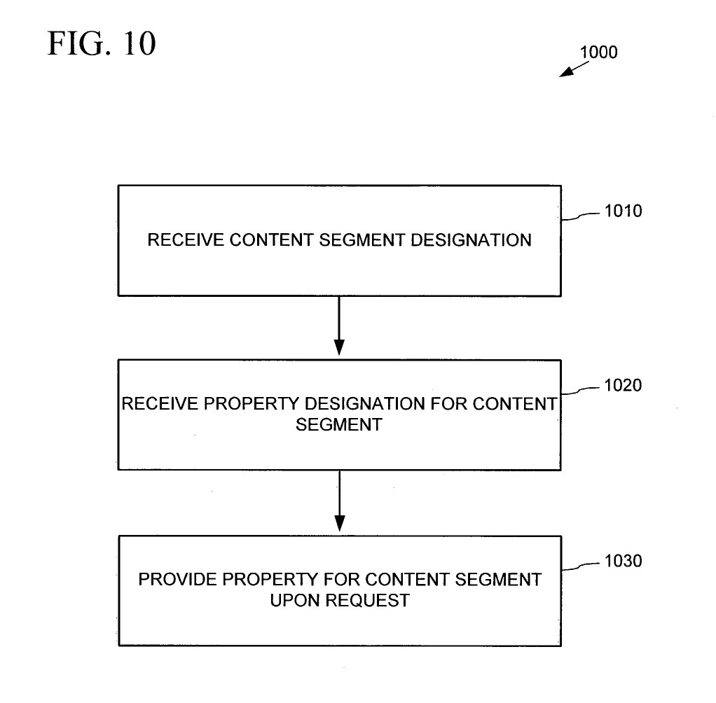

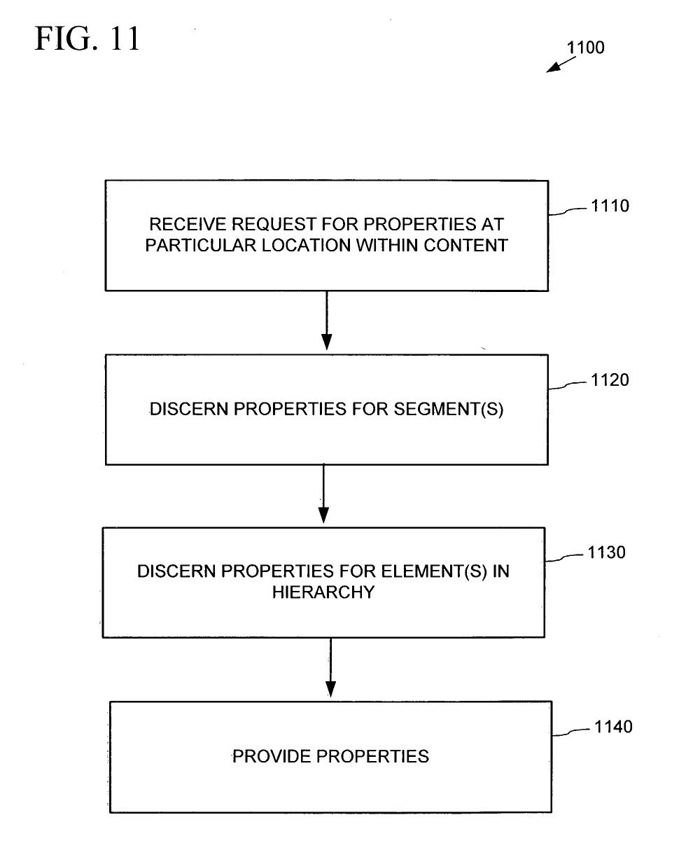

FIG. 10 shows an exemplary method 1000 for processing properties for a content segment. The method 1000 can be provided by a user interface service.

At 1010, a designation of a content segment is received. At 1020 a property designation for the content segment is received and stored. Then, at 1030, the property (e.g., the property's value) for the content segment is provided upon request.

In some cases, the request for the property may take the form of a request for the properties associated with a particular location (e.g., character position) within content. If desired, the provided properties can be assembled in light of properties of both the content segment and the hierarchy (e.g., an enclosing node, which may include a formatting directive). If desired, the properties can be taken from the content segment only. Or, properties in the hierarchy can override those of the segment, or vice-versa.

If desired, certain properties can be defined as to be taken from the content segment, with further designation as to whether they are to be overridden by nodes in the hierarchy. Precedence rules can be defined generally (e.g., segments take precedence over nodes or vice versa), property-specific (e.g., for a particular property, nodes take precedence over segments or vice versa), or some combination thereof.

An example of property determination can be illustrated with reference to FIG. 3. If, for example, if the “tree” text were enclosed by a node in a hierarchical representation having a color property set to blue, the “tree” text would ordinarily be rendered in the color blue. However, a content segment can be defined to cover the span 312 (i.e., the text “ee of m”) and have a color property set to green.

In the example, based on the presence of the content segment, property precedence can be defined so that a request for the color property for the text “ee” returns “green” (i.e., the property of the segment takes precedence over that of the enclosing node). Thus, the text “ee” can be rendered in the color green. In this way, properties from nodes in the hierarchy can be processed in conjunction with properties of content segments.

### Exemplary Stacking for Content Segments

If desired, content segments can be stacked on top of each other via specifying a z-order. Those having a higher z-order (e.g., visually on top) can take precedence over those having a lower z-order. For example, when a request for properties for a particular character position is received, the properties associated with the content segment having the highest z-order can be provided. Similarly, events can be sent to such segments before sending them to segments having a lower z-order.

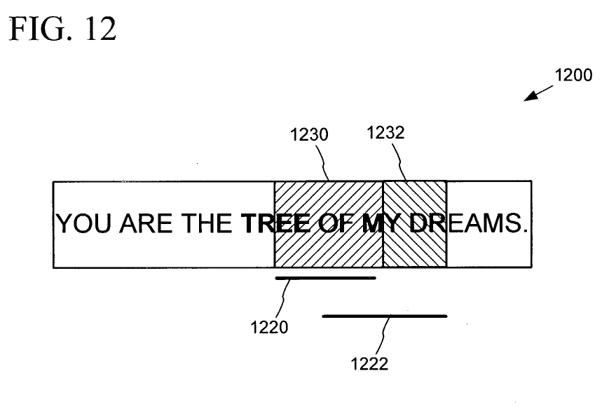

FIG. 12 shows an exemplary rendering 1200 performed for content segments having a different z-order. In the example, a first content segment is designated as spanning the content 1220 (i.e., the text “ee of m”) and a second content segment is designated as spanning the content 1222 (i.e., the text “of my dr”). However, the first content segment is defined with a higher z-order, so it is depicted as on top of the second content segment (e.g., via color, shading, or some other visual property).

The z-order can be implemented in a number of ways. For example, an order can be stored with the content segment (e.g., as a value or a reference to a value).

### Exemplary Non-Contiguous Spans

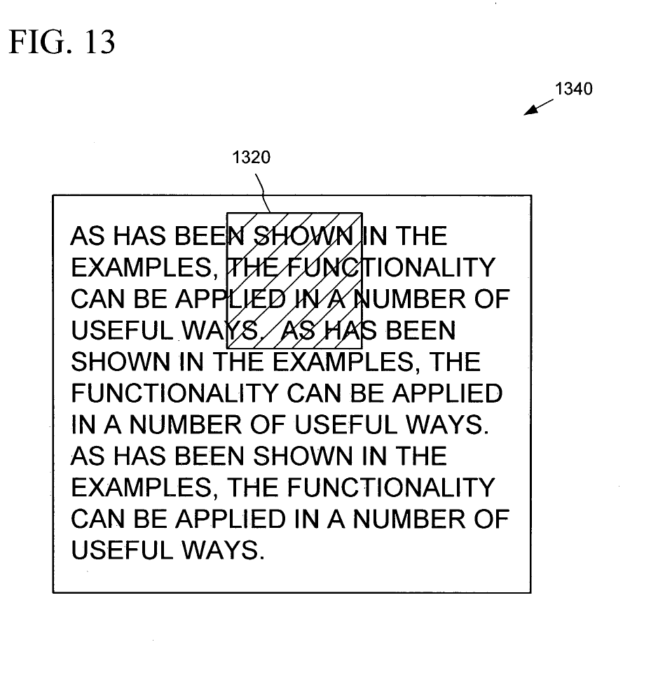

If desired, content segments can be implemented as non-contiguous. Such a segment can be considered one logical span, even if visually or otherwise disjointed. For example, a rectangular selection of text may be desired. FIG. 13 shows a visual depiction of an exemplary non-contiguous content segment 1320 within the content 1340.

Non-contiguous content segments can be implemented in a variety of ways, including the sub-span mechanism described below. The non-contiguous content segment can store two or more non-contiguous bounds.

In practice, the text associated with the content segment 1320 might not exactly correspond to the visual depiction of the content segment 1320. For instance, in the example, half of the letter “N” is shown as within the segment. If desired, a custom rendering mechanism can be used for the selection area (e.g., a rectangle), even though the content segment itself does not have any “half” characters. Alternatively, a more precise visual depiction can be presented (e.g., showing the characters as either completely selected or not selected at all).

### Exemplary Sub-Segments within a Content Segment

If desired, a content span can be defined as one or more sub-segments. Such a mechanism can be useful for implementing disjointed spans, as described above.

Sub-segments can be implemented so that there is one event handler and one set of properties for the sub-segments within a content segment. Such an approach is appropriate when implementing user selection.

However, if desired, sub-segments for a content segment can be permitted to have different properties, but one event handler. Such an approach is useful when implementing annotations, spell check data, or a handwriting bitmap.

For example, in an example related to spell checking, one event handler may be desired (e.g., how to handle user input related to a detected misspelled word), but the properties may be different (e.g., for the different detected misspelled words).

Further, if desired, sub-segments for a content segment can be implemented so that they can have different sets of properties and different event handlers, but are still treated as a single content segment for certain purposes.

### Exemplary Continuous Content Segments

In some cases, it may be desirable to have a variety of properties or event handlers for contiguous sub-spans of sequential data. Because the sub-spans are contiguous, certain optimizations can be made during representation and processing. Such a mechanism is sometimes called a “continuous content segment.”

Possible representation optimizations include storage. For example, one position can be stored per sub-span (e.g., the boundary with the next sub-span), rather than the two (e.g., beginning and end) typically stored when segments are disjoint. Also, certain processing may benefit from maintaining continuity between the sub-spans.

One exemplary implementation of continuous content segments is spell checking. For example, a background spell checker can examine sequential text and mark a piece of text (e.g., a sub-span defined by a sub-segment in a continuous segment) as correct, incorrect, or unchecked.

Another exemplary implementation of continuous content segments is a piece table. Such a table is sometimes used by text editors for efficiently representing content coming from plural data sources, content carrying various temporary properties, or both.

### Exemplary Rendering of Content

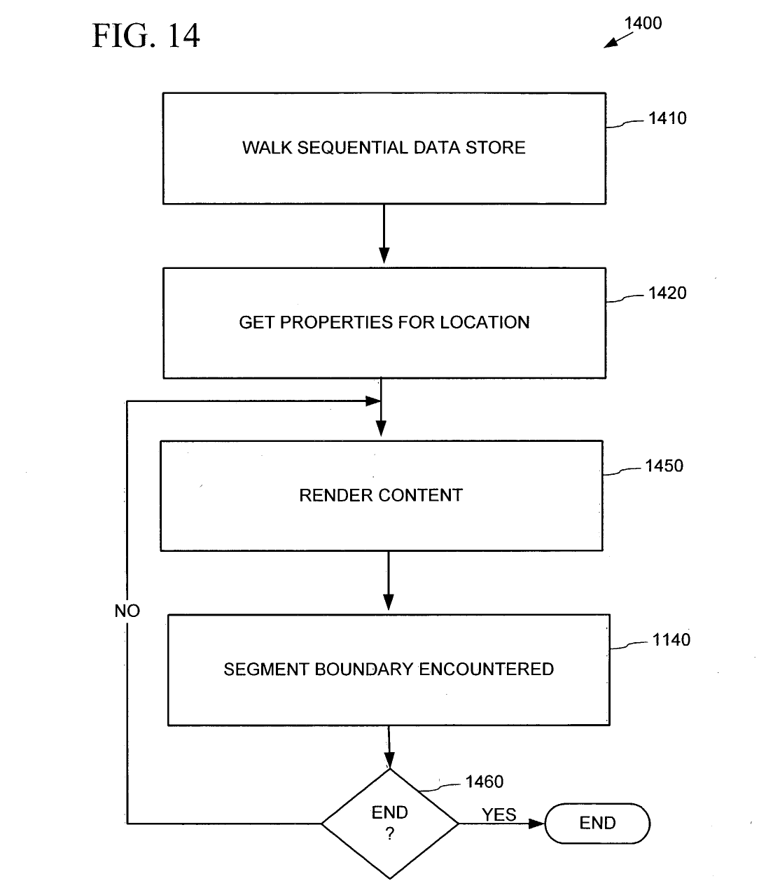

A visual depiction of content segments can be displayed when rendering content having associated content segments. An exemplary method 1400 for rendering content is shown in FIG. 14. The method 1400 can navigate through the content (e.g., the sequential data 762 of FIG. 7) and presents it for display to a user (e.g., on a display device such as a computer monitor).

At 1410, the method begins to walk the sequential data store (e.g., at a location to be rendered). At 1420, properties for the location are acquired. At 1430, the content is rendered according to the properties. Such rendering continues until a segment boundary is encountered at 1450. If the end of the content to be rendered is reached at 1460, the method ends. Otherwise, properties are again acquired at 1420, and content is further rendered.

In the example, a content segment edge is considered a boundary. In this way, properties need only be re-evaluated when a potential change is encountered. The properties can be based both on the content segments and nodes (e.g., elements, such as user interface elements or formatting directives) in the hierarchy.

### Exemplary Enumeration of Content Segments

If desired, content segments having a particular characteristic can be enumerated. For example, if a content segment type is provided, it can be implemented so that those content segments having a particular type are provided upon request.

For example, a spell checker may request the content segments of the “spelling error” type. The spell checker need not traverse the segments or the hierarchy to discover such content segments.

### Exemplary Implementation with Quad Tree

To track the locations of content segments, a quad tree can be used. A quad tree is a data structure in which data comprising a pair (e.g., starting and ending positions) is organized via boundaries dividing a grid of the data into sub-grids (e.g., four sub-grids, thus the name “quad” tree). The sub-grids can be further (e.g., recursively) subdivided. In this way, determining whether a particular position of span is contained within a content segment (e.g., out of a set of content segments) is more efficiently accomplished.

For example, when detecting whether a mouse pointer is positioned over any of the defined content segments, the quad tree can be used rather than searching through each of the content segments (e.g., to check their bounds). If the mouse pointer is positioned over a content segment, an appropriate event can be sent to the content segment.

Typically, if data in the quad tree is modified (e.g., the data points move), the quad tree (e.g., boundaries for the grids or designated grids indicating where the data points lie) needs to be re-calculated. However, in certain situations (e.g., where the data points automatically move together as in a sequential data store scenario), a data point itself can serve as a grid boundary. In such a case, as data is added, the boundary automatically shifts and recalculation can be avoided.

In any of the depicted examples herein, content segments or other spans of content can be tracked by a quad tree wherein at least one of the boundaries is itself a data point (e.g., a span associated with a segment). Tracking content spans in such a way can be helpful, for example, when determining whether a mouse pointer has been moved over a content span.

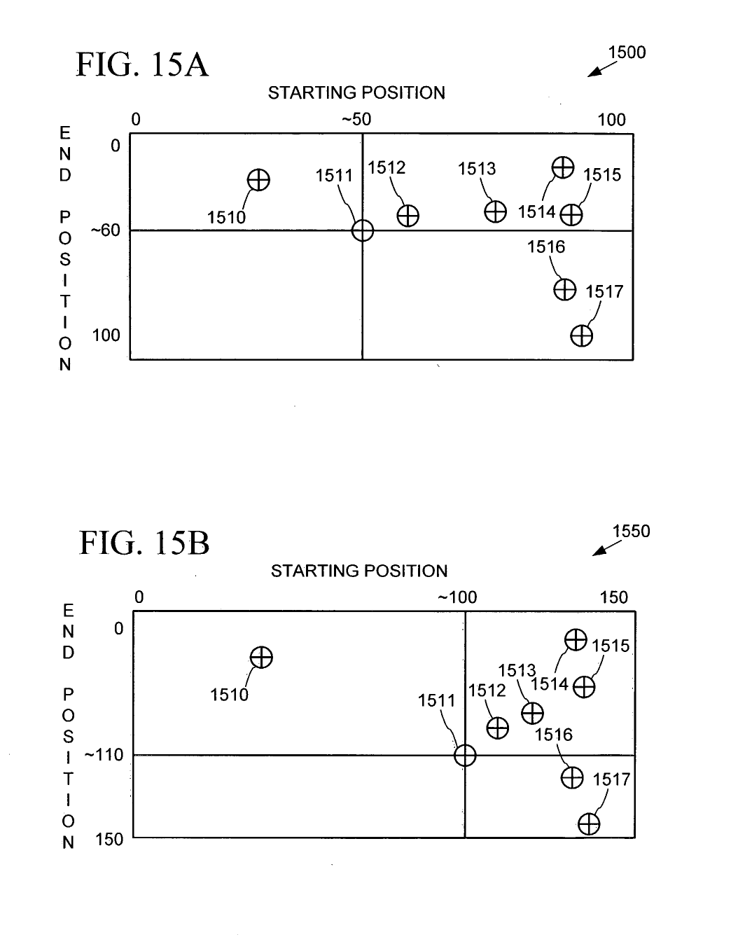

FIG. 15 depicts a quad tree 1500 for tracking the bounds of content segments. In the example, the 8 data points (e.g., points 1510-1517) track 8 content segments. The points can refer to a linking data structure (e.g., a splay tree in which the number of characters in the left sub-tree are stored). Point 1511 is special in that it both refers to content segment (with bounds from position 50 to position 60) and it serves as a boundary, thus forming four quadrants: (0-50, 0-60), (50-100, 0-60), (0-50, 60-100), and (50-100, 60-100).

Accordingly, as data is inserted into the sequential data store, the positions of the points are automatically updated (e.g., due to the shifting of the text by the insertion). Such an arrangement is possible due to the fact that the data points maintain a neighborly relationship with one another (e.g., if point a's start value is less than point b's start value, such will be the case, even if additional data is added to the sequential data store). Accordingly, in a situation in which 50 characters are added to character position 25, the arrangement 1550 shown in FIG. 15B results. The point 1511 need not be changed because the nodes it refers to in the linking data structure now refer to different character positions. The point 1511 now refers to a content segment spanning position 100 to position 110 (i.e., the same content segment) and it forms the following four quadrants (0-100, 0-110), (100-150, 0-110), (0-100, 110-150), and (100-150, 110-150).

Similarly, if data is removed, the grids automatically shrink. The grids can shrink such that they become zero size, in which case some grids can be coalesced. Although data is shown in two dimensions, it is possible to increase the dimensions and still take advantage of the described technology.

### Exemplary Quad Tree

Table 1 shows an exemplary definition of data members that can be included in a class definition for a quad tree.

TABLE 1
Data Structure for Quad Trees

private TreePos m_startLo;
private TreePos m_startHi;
private TreePos m_endLo;
private TreePos m_endHi;
private object m_segmentsOrGrids
private book m_hasSegments

In the example, the first four members define the bounds of the four sides of the grid. These first four members serve as pointers into the linking data structure that maintain their position as content is added or removed from the tree. The m_segmentsOrGrids member points to either a collection of sub-grids (e.g., if m_hasSegements is true) or a collection of data points for the particular grid (e.g., if m_hasSegments is false).

The data points used for grid boundaries can be shared between multiple grids, or each grid boundary can be represented by a different data point.

### Exemplary Detailed Implementation for Properties For a Span

The property mechanism described herein can be used to provide arbitrary property sheets for spans of data, even if a hierarchy is not involved. For example, a program can define new properties not previously known to the user interface service. Property values for such properties can be stored and retrieved for spans via the user interface service. The spans of content can be, but need not be, content segments.

### Exemplary Detailed Implementation of Exemplary Data Structures

Various data structures can be used in conjunction with the technologies. For example, a Segment or Subsegment data structure can include the fields shown in Table 2. The data structure can be implemented as part of an object class.

TABLE 2
Data Structure for Segment

| // m_subsegments is either a single subsegment if there is only | |
|---|---|
| // one (e.g., for the case of a contiguous segment) or | |
| // an array of subsegments if there is more than one | |
| object m_subsegments; | // Single subsegment or |
| | // array list of subsegments |
| int m_z_order; | // Zorder of this segment |

An internal subsegment can be stored in m_subsegments, which has the structure shown in Table 3. Externally, the subsegment is exposed as two special pointers that have a position in the splay tree.

TABLE 3
Data Structure for Internal Subsegment

| | | |
|---|---|---|
| TreePosStruct | m_tpBegin; | // Splay tree structure for |
| | | // beginning of this subsegment |
| TreePosStruct | m_tpEnd; | // Splay tree structure for end of |
| | | // this subsegment |
| Segment | m_segment; | // Pointer to associated segment |
| bool[] | m_gravity | // gravity flags, which tell |
| | | // where inserted content will go |
| | | // at the edges of the segment |
| | | // (e.g., will it go before |
| | | // the edge or after the edge) |

Additions, omissions, and alterations to the described data structures can be made as desired while still achieving an implementation of the technologies.

### Exemplary Operation

The following example describes possible operation of the technologies described herein. In the example, a content segment is created and an event handler is associated with the content. The technologies can be applied in innumerable other ways.

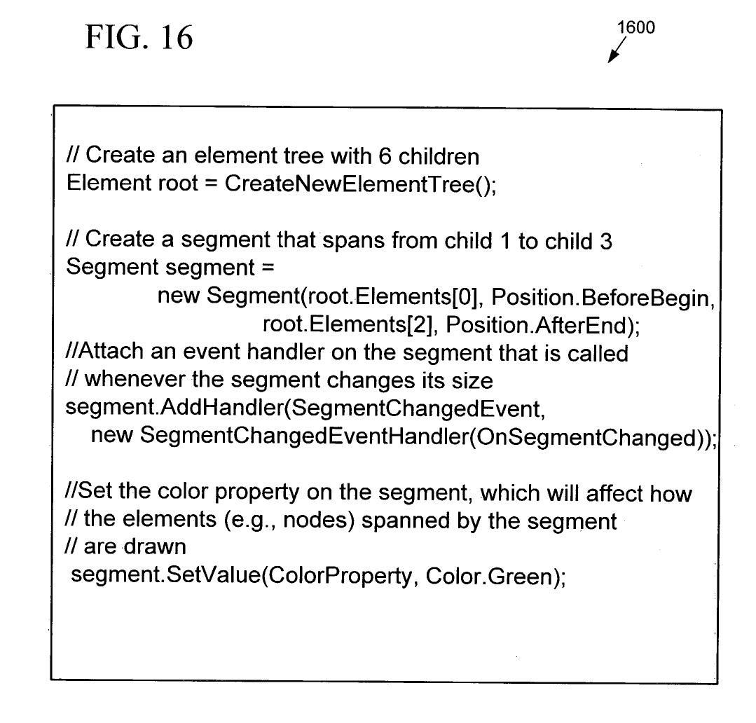

FIG. 16 shows exemplary source code 1600 for achieving exemplary operation of the technologies. In the example, a hierarchical representation called “root” is created. A content segment called “segment” is created to encompass nodes of the hierarchical representation, and an event handler is associated with the content segment. Also, the property of the segment is set to be “Green.”

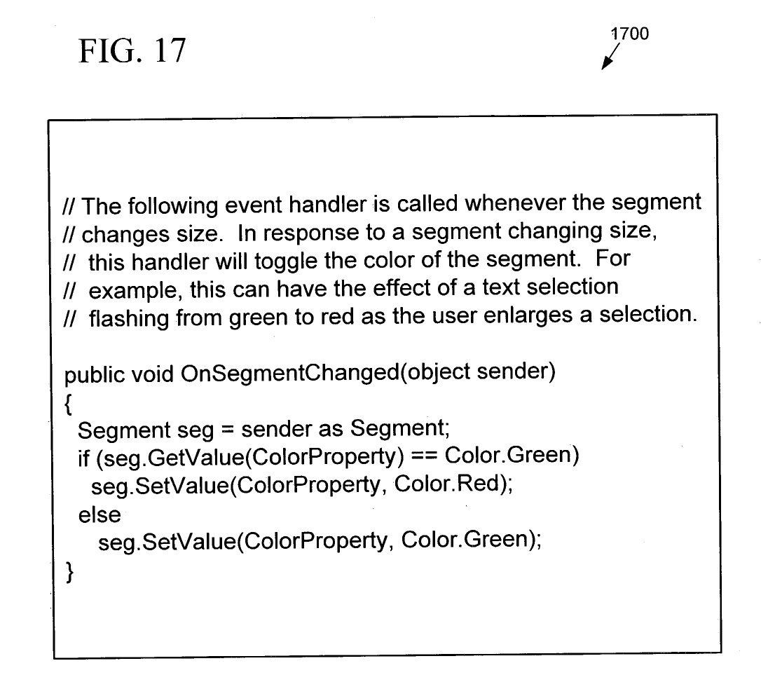

FIG. 17 shows exemplary source code 1700 for the event handler associated with the content segment created via the source code 1600. The handler is called whenever the content segment changes size.

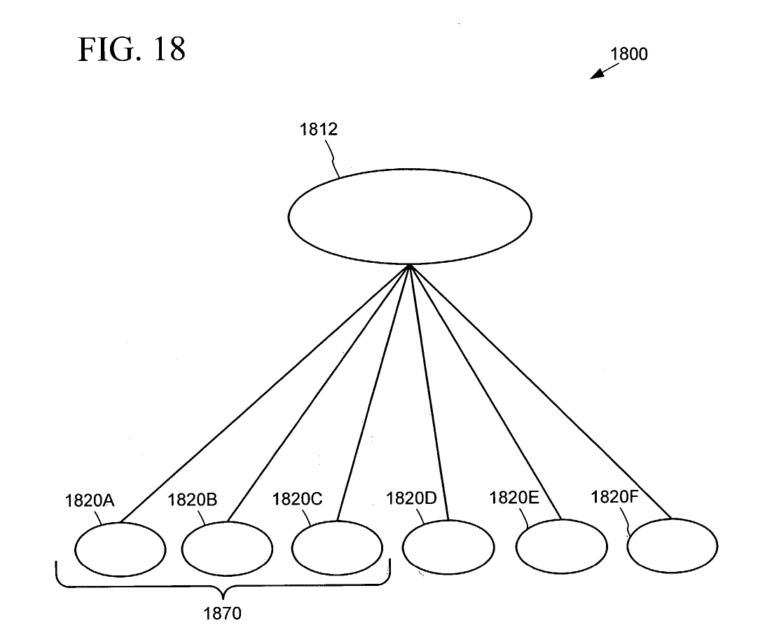

FIG. 18 depicts a hierarchical representation 1800 generated via the code 1600 and includes the nodes 1820A-F. The nodes 1820A-C are encompassed by the segment 1870.

### User Interface Services

Any of the features described herein can be provided as part of a user interface service (e.g., as part of a user interface framework for an operating system). Content segments can be implemented as an object class via which client programs can interact with the functionality described herein.

### Exemplary Content

The content described herein can include sequential data (e.g., text, audio, or video), UI elements, formatting directives, and the like. Typically, such content is presented to a user or affects such a presentation.

### User Interface Elements

The user interface elements depicted herein can be any of a variety of user interface elements. For example, graphical pushbuttons, checkboxes, radio buttons, scroll bars, form fields, controls (e.g., controls adhering to the MICROSOFT ActiveX format or OCX's), and the like can be used. As new types of user interface elements are developed, they can be incorporated into the described technologies.

### Alternatives

Having described and illustrated the principles of our invention with reference to illustrated embodiments, it will be recognized that the illustrated embodiments can be modified in arrangement and detail without departing from such principles.

Although some of the examples depicted herein show sequential data as text, implementations using audio, video, or some other sequential data can also be constructed.

Although some of the examples depicted herein show the technologies as applied to documents, the technologies can also be equally applied an any number of other scenarios, such as user interface representation (e.g., representing the user interface of a word processing or email program).

Although some of the examples show nodes having various references or pointers to other nodes, some references or pointers can be omitted, added, or modified as desired. Also, in the case of a bi-directional pointer, a pointer in one direction can be used (e.g., in conjunction with some other mechanism for navigating in the other direction, if desired).

It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa. In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

We claim:

1. A method of specifying a span of data within a representation of content associated with a hierarchical representation for the content, the method comprising:
receiving a designation of the span within the content; and
creating a representation of a content segment associated with the span without modifying the hierarchical representation for the content.

2. The method of claim 1 wherein the span within the content spans sequential data.

3. The method of claim 1 wherein:
the content comprises sequential text; and
the designation of the span indicates a span of the sequential text.

4. A computer-readable medium comprising computer-executable instructions for performing the method of claim 1.

5. The method of claim 1 wherein the hierarchical representation is stored in a tree data structure.

6. The method of claim 5 wherein the hierarchical representation comprises nodes representing formatting directives for the content.

7. The method of claim 5 wherein the hierarchical representation comprises nodes representing markup tags for the content.

8. The method of claim 5 wherein the hierarchical representation comprises at least one node representing a markup language bold tag.

9. The method of claim 1 wherein the designation comprises a beginning location and an ending location of the span.

10. The method of claim 9 wherein the representation of the content stores the beginning location and the ending location as references to a linking data structure, wherein the linking data structure refers to locations within the content.

11. The method of claim 10 wherein the hierarchical representation comprises at least one node associated with the content via the linking data structure.

12. The method of claim 11 wherein the linking data structure comprises a splay tree.

13. The method of claim 1 wherein the content segment is associated with the content via a linking data structure having nodes referring to locations within the content.

14. The method of claim 13 the linking data structure comprises a splay tree.

15. The method of claim 1 wherein the designation comprises a content segment type.

16. The method of claim 15 further comprising:
upon request, enumerating segments having the segment type.

17. The method of claim 1 wherein the span comprises non-contiguous content.

18. The method of claim 1 wherein the content segment comprises a plurality of sub-segments.

19. The method of claim 18 wherein at least two of the sub-segments have different properties associated therewith.

20. The method of claim 18 wherein at least two of the sub-segments have different event handlers associated therewith.

21. The method of claim 18 wherein:
the plurality of sub-segments comprises contiguous sub-segments; and
spans of the contiguous sub-segments are represented with respective single boundaries.

22. The method of claim 1 further comprising performing an operation on the content segment.

23. The method of claim 1 further comprising:
providing a copy of the span associated with the content segment without modifying the hierarchical representation for the content.

24. The method of claim 1 further comprising:
depicting the span visually with a presentation of the content as highlighted.

25. The method of claim 1 wherein the hierarchical representation comprises formatting directives for the content.

26. The method of claim 1 wherein the hierarchical representation comprises user interface elements to be presented in conjunction with the content.

27. The method of claim 1 further comprising:
receiving an indication of a specified function to be performed upon detection of an event for the span; and
upon detection of the event for the span, invoking the specified function.

28. The method of claim 27 wherein:
the content segment spans a node in the hierarchical representation; and
the specified function takes precedence over an other function, wherein the other function is associated with the node in the hierarchical representation.

29. The method of claim 27 wherein the event comprises a change to a property associated with the span.

30. The method of claim 27 wherein the event comprises inputting data into the span.

31. The method of claim 30 wherein the data is input via a keyboard.

32. The method of claim 27 wherein the event comprises receiving a command via speech recognition.

33. The method of claim 27 wherein the event comprises a change to a portion of the hierarchical representation relating to the span.

34. The method of claim 1 further comprising:
receiving an indication of a property for the span; and
storing the indication as associated with the span.

35. The method of claim 34 wherein:
the content segment spans a node in the hierarchical representation; and
the property takes precedence over an other property, wherein the other property is associated with the node in the hierarchical representation.

36. The method of claim 34 wherein the property is inheritable.

37. The method of claim 1 further comprising:
receiving a z-order for the content segment.

38. The method of claim 37 further comprising:
processing the content segment as stacked on top of another content segment having a lower z-order.

39. The method of claim 37 further comprising:
visually depicting the content segment as on top of another content segment having a lower z-order.

40. The method of claim 37 further comprising:
sending an indication of a detected event to the content segment before sending the event to another content segment having a lower z-order.

41. A method of specifying a span of data within a representation of text associated with a hierarchical representation for the content, wherein the hierarchical representation comprises a plurality of nodes representing markup language tags associated with the text, the method comprising:
receiving a designation of the span within the text, wherein the designation comprises a starting location and an ending location;
creating nodes in a linking data structure for the starting location and the ending location, wherein the linking data structure is a splay tree linking the hierarchical representation to the text; and
creating a representation of a content segment associated with the span, without modifying the hierarchical representation for the content, wherein the representation comprises references to the created nodes in the linking data structure.

42. A computer-readable medium having encoded thereon a data structure comprising:
content;
a hierarchical representation associated with the content; and
a designation of a span of the content, wherein the designation does not modify the hierarchical representation.

43. The method of claim 42 wherein the hierarchical representation is stored as a tree data structure.

44. The method of claim 42 wherein
hierarchical representation and the span of content are linked to the content via a linking data structure.

45. A user-interface service comprising:
code for receiving a designation of a span of data within content having an associated hierarchical representation; and
code for storing the designation without modifying the associated hierarchical representation.

46. The user-interface service of claim 45 wherein the hierarchical representation comprises formatting directives implemented when rendering the content.

47. A user-interface service comprising:
a function for accepting a designation of a span of content having an associated hierarchically-arranged representation, wherein at least a portion of the content is rendered in a presentation to a user, and the span corresponds to visual locations within the presentation over which an action can be performed;
a function for accepting a designation of functionality to be invoked when an action is performed over the presentation; and
an event-monitor for detecting when an action occurs within the visual locations, and responsive to such detecting, invoking the functionality.

48. The user-interface service of claim 47 wherein the action is positioning a mouse.

49. A user-interface service comprising:
means for accepting a designation of a span of content having an associated hierarchically-arranged representation, wherein at least a portion of the content is rendered in a presentation to a user, and the span corresponds to visual locations within the presentation over which an action can be performed;
means for accepting a designation of functionality to be invoked when an action is performed over the presentation; and
means for detecting when an action occurs within the visual locations, and responsive to such detecting, invoking the functionality.

50. A method of specifying a span of content within content represented by a tree structure having a hierarchy, the method comprising:
receiving a designation of a beginning and an ending of the span, wherein the span crosses a boundary in the hierarchy; and
designating the span as crossing the boundary in the hierarchy without modifying the tree structure having a hierarchy.

51. The method of claim 50 wherein the tree structure having a hierarchy comprises formatting directives for the content.

52. The method of claim 50 wherein the tree structure having a hierarchy comprises nodes representing user interface elements.

53. In a user interface service, a method of defining an arbitrary property for a span of content, the method comprising:
receiving a designation of a beginning and an ending of the span;
receiving a designation of the property for the span, wherein the property is a custom property not recognized by the user interface service; and
storing the designation of the property.
